(19) United States
(12) Patent Application Publication
(10) Pub. No.: US 2008/0070197 A1
(43) Pub. Date: Mar. 20, 2008

(54) Interactive toy vehicle cockpit

(75) Inventor: Glenn Yu, San Marino, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: Mattel, Inc.

(21) Appl. No.: 11/524,717

(22) Filed: Sep. 20, 2006

(51) Int. Cl. G09B 9/04

(52) U.S. Cl. 434/62

(57) ABSTRACT

A method of operation of a toy cockpit for use with a carrier vehicle, comprising receiving an operator input and providing at least one of an audible output and a visual output in response thereto; and receiving a carrier vehicle input and providing said at least one of the audible output and the visual output in response thereto.

### BACKGROUND AND SUMMARY

Some toys may simulate a cockpit or control panel of a vehicle such as an automobile or aircraft. These cockpit style toys may include user inputs such as steering wheels, buttons (e.g. a horn), and levers. However, in some cases, these toys may provide limited play patterns, thereby rendering the toy uninteresting to the user after the play patterns are exhausted.

The inventors of the present disclosure have recognized additional play patterns for a cockpit style toy. As one example, an additional play pattern may include providing audible or visual commands to the user that encourages them to follow the commands by providing specific user inputs. Feedback in the form of a visual, audible, and/or haptic response may be used notify the user that the command was sufficiently followed, thereby providing a coaching function. As another example, an additional play pattern may include varying the feedback provided to the user based on a condition of a carrier vehicle, such as an automobile of which the user and cockpit toy are passengers. As still another example, an additional play pattern may include simulated collisions in which components of the cockpit disassemble in response to user or carrier vehicle inputs. These additional play patterns may be combined with each other or used separately to achieve increased user interaction and varying levels of toy play.

### BRIEF DESCRIPTION OF THE DRAWINGS

FIG. 1 illustrates a front view of the toy cockpit as experienced by the user.

FIG. 2 illustrates a right side view of the toy cockpit.

FIG. 3 illustrates a front view of the toy cockpit exposing inner components of the cockpit.

FIG. 4 illustrates a right side view of the toy cockpit exposing inner components of the cockpit.

FIG. 5 illustrates a schematic diagram of a control system for the cockpit.

FIG. 6 illustrates a control routine that may be performed by the control system of the cockpit.

FIG. 7 illustrates an embodiment where one or more portions of the cockpit may vibrate in response to operating conditions.

FIG. 8 illustrates an embodiment where one or more portions of the cockpit may become separated or re-configured with respect to the cockpit frame.

### BACKGROUND AND SUMMARY

The present disclosure relates to a toy cockpit that may be used, for example, by a user such as a child. In some embodiments, the toy cockpit can simulate a vehicle cockpit such as an automobile and may include one or more user controls and/or gauges representative of the particular vehicle that is simulated. For example, the cockpit may include a steering wheel, a gear shifter and one or more instruments or gauges such as a speedometer and tachometer. Further, the cockpit described herein, may respond to operation of a carrier vehicle that is transporting the toy cockpit and user. For example, the cockpit may provide response or feedback to the user via lights, sounds, actions, etc. in response to the acceleration or movement of the carrier vehicle. Further, under some conditions, the cockpit may provide verbal or visual commands to the user to perform specific control functions such as turning the steering wheel or moving the gear shifter. In this manner, the cockpit may provide feedback to the user in response to conditions of the carrier vehicle and/or user response to issued commands, thereby improving user/toy interaction.

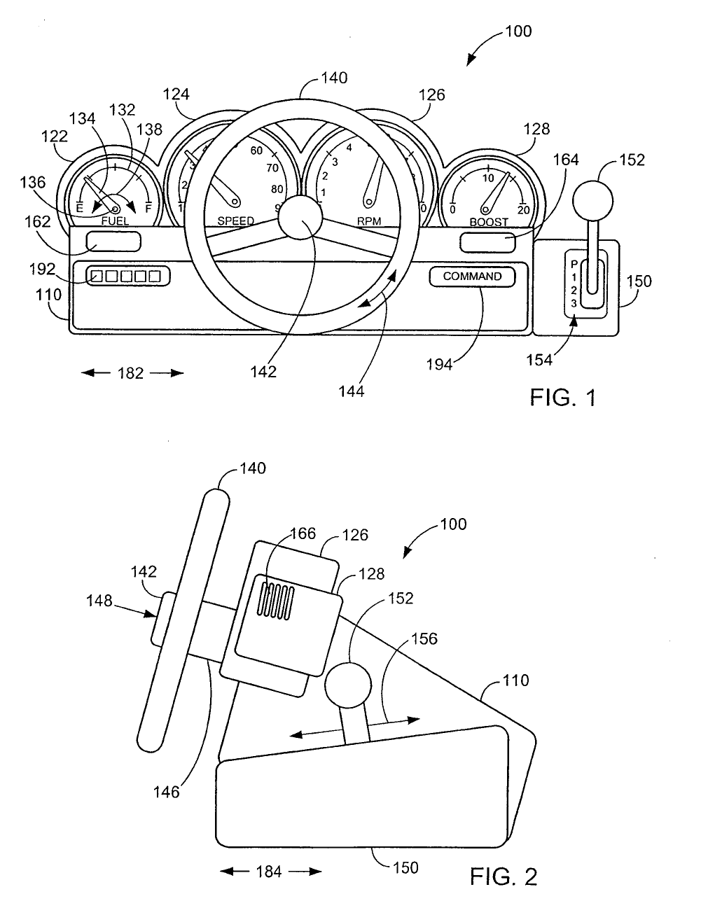

Referring now to FIGS. 1 and 2, a cockpit 100 is illustrated. Cockpit 100 may be used by a user when riding in a carrier vehicle such as an automobile. Cockpit 100 may placed on the lap of the user during use, may be coupled to the carrier vehicle or car seat, or may be operated outside of a carrier vehicle such as on a floor or table. In some embodiments, frame 110 of cockpit 100 may include one or more anchor points for securing the cockpit to the carrier vehicle, car seat, or other object. For example, the cockpit may be secured to the back side of a front seat of a car for use by a child seated in a rear seat.

A cockpit 100 may include a frame 110 including one or more gauges 122, 124, 126, and 128, a steering wheel 140, and a shifter 152. Gauges 122, 124, 126, and 128 may include indicia 132 and a moveable indicator 134 shown with reference to Gauge 122. Indicator 134 may rotate under some conditions as indicated by vector 138 about an axis of rotation 136 to provide a particular visual indication to the user. Thus, one or more of the gauges may include indicators that can rotate or move so as to vary the visual indication provided by the gauge. As one example, as illustrated in FIG. 1, gauge 122 may provide information relating to fuel level, gauge 124 may provide information relating to vehicle speed (e.g. provide a speedometer operation), gauge 126 may provide information relating to engine rpm (e.g. provide a tachometer operation), and gauge 128 may provide information relating to a level of boost. In some embodiments, the gauges may be back lit or may include a light. Further, other gauges are possible, depending for example, on the type of vehicle cockpit that is simulate by cockpit 100. In this manner, cockpit 100 may simulate instrumentation that may be found on the instrument panel of a vehicle such as an automobile.

Steering wheel 140 is shown moveably coupled to frame 110 by steering column 146. Steering wheel 140 may be rotated by a user about an axis of the steering wheel as indicated by vector 144. Steering wheel 140 may include a button 142 that may be depressed or activated by a user as indicated by vector 148 to cause a sound such as that of a horn to be emitted from one or more speakers of the cockpit. A side portion 150 simulating a gear shift may be arranged on the right or left side of the frame. Side portion 150 may include a shifter 152 that may be moved between two or more positions as indicated by vector 156. Indicia 154 may be included on a face of side portion 150 to provide visual indication of the selected position of the shifter as well as providing an indication of other positions that may be selected. In this particular example, the shifter may moved to four different positions indicated by “P”, “1”, “2”, and “3”. “P”, for example, may represent a parked state of cockpit. “1”, “2”, and “3” may represent different gears that may be selected by the user. In this manner, shifter 152 may simulate a gear shifter that may be found in a vehicle such as an automobile.

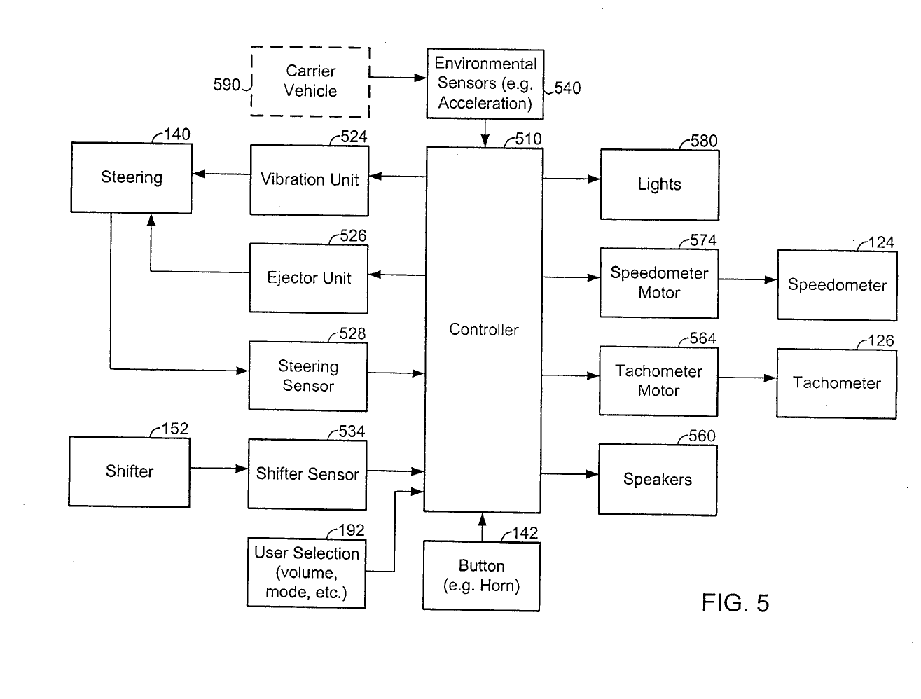

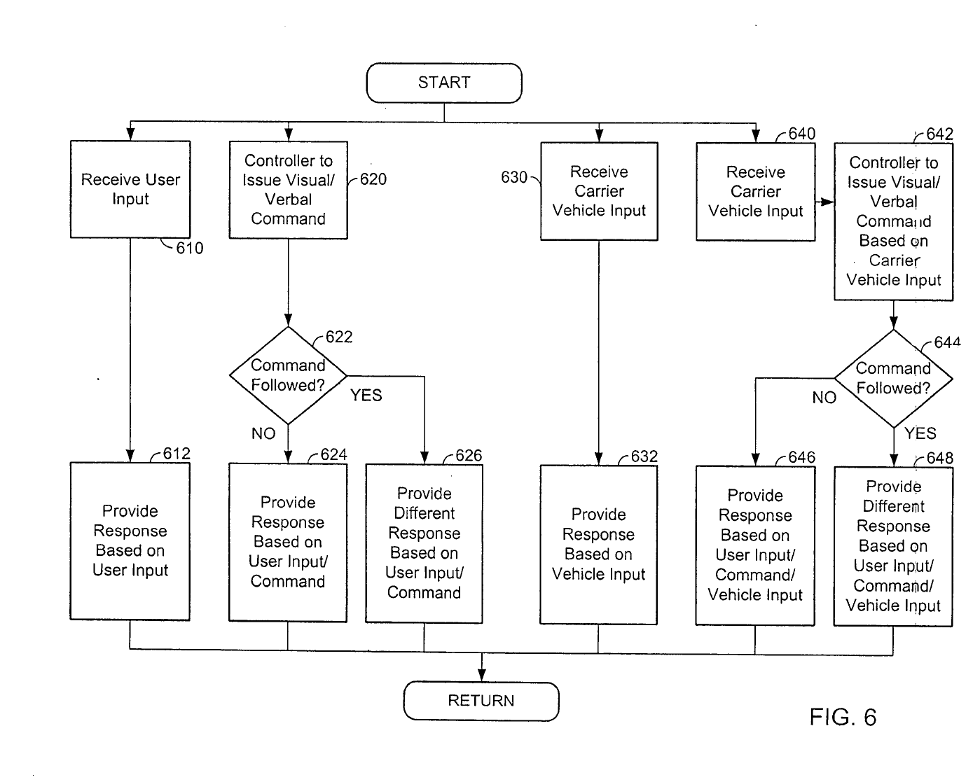

Cockpit 100 may include one or more speakers such as left speaker 162 or right speaker 164. Cockpit 100 may include other speakers or speakers in alternative locations such as speaker 166 as shown on the right side view of the cockpit as illustrated by FIG. 2. Cockpit 100 may also include yet another speaker located on the left side of the cockpit in a similar configuration as speaker 166. In some conditions, two separate speakers such as speakers 162 and 164 may be operated to produce sounds in stereo. For example, a horn sound may be emitted by one or more speakers in response to a user depressing button 148. As another example, engine sounds, tire sounds, or shifting sounds may be emitted by one or more speakers in response to a condition of the carrier vehicle or one or more user inputs such as shifter 156 or steering wheel 140. As yet another example, tire squeal and/or tire squish sounds may be emitted by one or more speakers in response to a user turning steering wheel 140 as indicated by vector 144. Further still, as will be described in greater detail with reference to FIGS. 5 and 6, other sounds may be emitted from one or more speakers, during some conditions, without necessarily requiring user input.

A command window 194 may be included to provide visual commands to a user. For example, a user may be encouraged to perform a specific control function such as rotating the steering wheel in a particular direction, or moving the shifter to a specific location. Further, a user selection panel 192 may be included for enabling a user to vary operation of the cockpit. For example, panel 192 may include a volume control, a power switch, a mode selection switch, etc. The power switch may include a key that can be turned by the user to turn the cockpit on/off, thereby simulating an ignition key. In some embodiments, the user may be able to select between different modes of operation, such as will be described with reference to FIG. 6. For example, a first mode may provide a visual and/or audible command to the user during operation of the cockpit, while a second mode may eliminate or reduce the commands or coaching provided to the user.

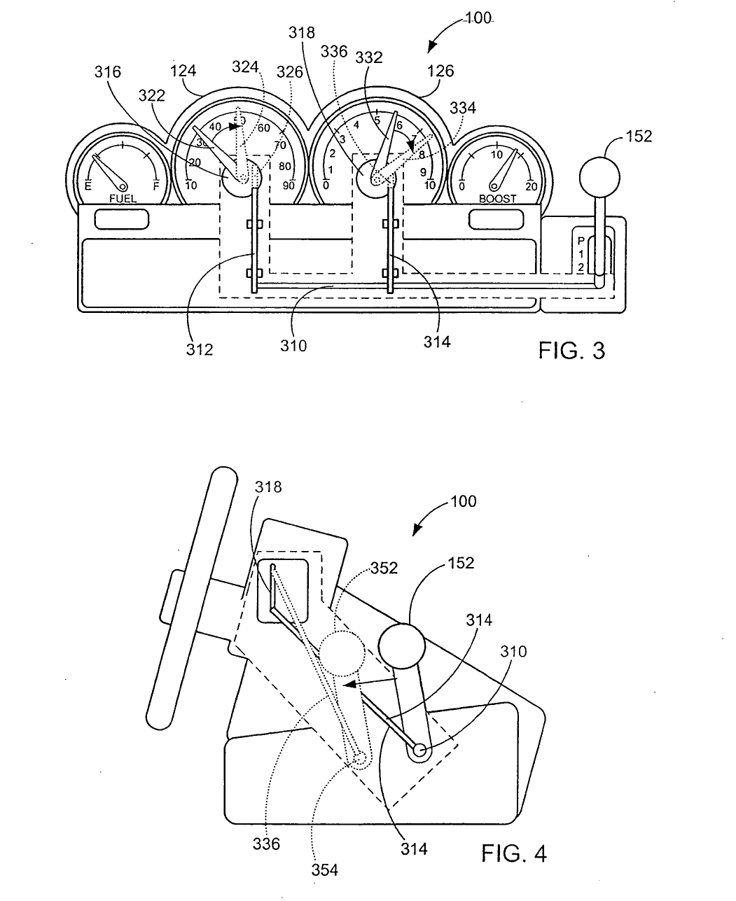

Referring now to FIGS. 3 and 4, cockpit 100 is illustrated with various portions removed exposing internal mechanical components of the cockpit. In particular, FIG. 3 shows a view similar to that of FIG. 1, with the steering wheel and portions of the frame omitted while FIG. 3 shows a view similar to that of FIG. 2 also with portions of the frame omitted to reveal mechanical linkages. In some embodiments, shifter 152 may be mechanically linked to gauges 124 and 126 via one or more linkages in a configuration that causes visual indication of the gauges to vary with the selected position of the shifter. As one example, shifter 152 may be coupled to indicator 332 of gauge 126 via one or more linkages such as a first linkage 310 and a second linkage 314. As the shifter is moved from a first position as indicated by 152 to a second position as indicated by 352, the first linkage 310 may move to a second position as indicated by 354. Similarly, movement of the first linkage may cause a corresponding movement of the second linkage 314 as indicated by 336. The second linkage 314 is shown coupled to a base 318 of indicator 332 such that movement of second linkage 314 causes indicator 332 to move to a second position as indicated by 334. In this manner, an input from the user, such as a movement of shifter 152, can cause one or more gauges of the cockpit to display different information.

As another example, the visual indication provided by gauge 124 may be adjusted by a third linkage 312 in response to movement of first linkage 310. Movement of linkage 312 as indicated by 326 may cause indicator base 316 to rotate, thereby moving indicator 322 to another position, as indicated by 324. During operation of the cockpit, the user may adjust the position of the shifter to vary the position of the indicators of one or more gauges through two or more different positions or configurations. As one example, at least the speedometer gauge 124 and the tachometer gauge 126 may indicate 0 when the shifter is set to a park position (e.g. “P” of indicia 154). The user may then move the shifter between a first gear (e.g. “1” of indicia 154), a second gear (e.g. “2” of indicia 154), and/or a third gear (e.g. “3” of indicia 154) to cause different speed and/or rpm readings to be provided by gauges 124 and 126, respectively.

It should be appreciated that other types of mechanical connections could be used to employ movement of one or more gauges of the cockpit in response to an input from a user. For example, gears, cables, linkages, etc. could be used to achieve a suitable or desired mechanical response to a user input. While FIGS. 3 and 4 illustrate a mechanical linkage or coupling between the shifter and the gauges, in other embodiments, the shifter may be instead linked electrically, as will be described in greater detail with reference to FIGS. 5 and 6.

Referring now to FIG. 5, a schematic diagram of a control system 500 for cockpit 100 is illustrated. While this example illustrates an electrical/electronic control system, a mechanical control system may also be used. Specifically, in the illustrated example, control system 500 may include an electronic controller 510 that may send or receive control signals from one or more components of the cockpit as well as receiving information relating to the carrier vehicle. For example, controller 510 may receive steering information such as position, speed, or acceleration of steering wheel 140 via steering sensor 528. As one example, steering sensor 528 may include a potentiometer, switch, or other electronic sensor that provides a signal to controller 510 in proportion to the movement of the steering wheel. Similarly, controller may receive shifter information such as position, speed, or acceleration of shifter 152 via shifter sensor 534. As described above with reference to sensor 528, shifter sensor 534 may include a potentiometer, switch, or other electronic sensor. Controller 510 may receive other user inputs such as button 142 for simulating a car horn or one or more user selections via panel 192, including volume selections, mode selections, etc. Controller 510 may receive information from the surrounding environment such as the carrier vehicle via environmental sensors 540. As one example, controller 510 may receive acceleration information from environmental sensor 540. As will be described in greater detail with reference to FIG. 6, sensor 540 may be used to indicate a condition of a carrier vehicle that is carrying the user and cockpit 100 including noise and/or acceleration. Sensor 540 may include one or more sensors for sensing acceleration of the cockpit, such as a rolling-ball inclination (electrical contact) sensor indicative of acceleration/inclination, a mechanical gyroscope, an accelerometer, etc. For example, the rolling-ball sensor may indicate either turning to the left or turning to the right (or a center position), or forward or reverse acceleration (or a center position). Alternatively, an accelerometer may indicate a level and direction of acceleration. In at least one approach, a first accelerometer may be used to provide side to side acceleration information with reference to a first vector 182 shown in FIG. 1 while a second accelerometer may be used to provide front to back acceleration information with reference to a second vector 184 as shown in FIG. 2. In this manner, lateral movement of the carrier vehicle (e.g. via turning) and acceleration or deceleration of the carrier vehicle (e.g. via braking) may be detected by controller 510.

The various signals received by controller 510 via one or more of steering sensor 528, shifter sensor 534, environmental sensor 540, button 142, and user selection panel 192, among others may be used by controller 510 to provide various responses or feedbacks to the user. As one example, with regards to the steering wheel, a vibration unit 524 may be activated by controller 510 to cause steering wheel 140 to vibrate, thereby providing haptic feedback (e.g. feedback relating to the sense of touch) to the user. In this manner, controller 510 can provide haptic feedback to a user based on one or more sensed conditions in addition to or as an alternative to audible and/or visual feedback. Vibration unit 524 may include, as one example, a motor having an unbalanced mass. Controller 510 can send a suitable level of electrical energy to the motor to cause the unbalanced mass to rotate or move, thereby causing vibration in the steering wheel or other portion of the cockpit. In some embodiments, such as with some motors, steering sensor 528 may be combined with vibration unit 524.

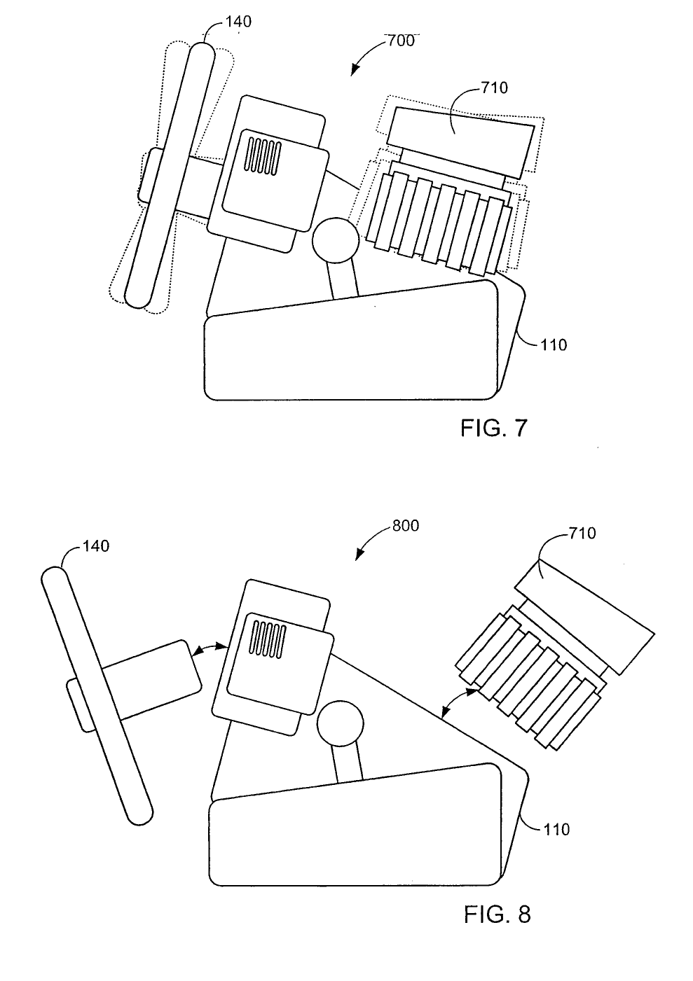

As another example, an ejector unit 526 may be included to cause separation or reconfiguration of cockpit 100 in response to a signal from controller 510. For example, controller 510 can cause steering wheel 140 to separate from frame 110 in response to one or more sensed conditions as shown in FIG. 7. Steering wheel 140 may be reattached to frame 110 by the user after it has been separated.

Controller 510 may cause one or more lights included with cockpit 100 to turn on or off based on sensed conditions. For example, during some conditions, such as when ejector unit 526 is operated to cause steering wheel 140 to separate from frame 110, one or more lights, such as those backlighting the gauges, may turn on or off, or may blink, etc. Operation of lights may be used to notify a user to perform specific functions, such as via command window 194.

Further, controller 510 may cause one or more gauges to provide different information to the user in response to one or more sensed conditions. For example, controller 510 can cause the indicator of speedometer gauge 124 to rotate to different positions via a speedometer motor 574 coupled to indicator 322, for example. Similarly, controller 510 can cause the indicator of tachometer gauge 126 to rotate to different positions via a tachometer motor 564 coupled to indicator 332, for example. Thus, one or more of the gauges may be varied electronically via controller 510 rather than mechanically as described above with reference to FIGS. 3 and 4.

Controller 510 may cause sound to be emitted by speakers 560 (e.g. speakers 162, 164, 166 of FIGS. 1 and 3) in response to various sensed conditions. As one example, controller 510 may cause speakers 560 to emit a horn sound in response to button 142 being depressed by the user. In some embodiments, the speakers may be included in headphones that are worn by the user and connected to controller 510 via an outlet in the surface of the frame, for example.

As another example, controller 510 may cause speakers to emit sounds in response to input received from an acceleration sensor. For example, speakers 560 may be controlled to output a tire squeal, skid or squish sound in response to a threshold level of lateral acceleration (e.g. via vector 182) sensed by an acceleration sensor. Further, speakers 560 may be controlled to output engine sounds such as engine revving, engine acceleration, engine deceleration, transmission shifting, etc. in response to acceleration in longitudinal direction (e.g. via vector 184) sensed by an acceleration sensor. For example, the pitch and/or volume of the sounds emitted by speakers 560 can be increased or decreased in response to the magnitude and/or direction of acceleration. Acceleration in the longitudinal direction may cause engine sounds emitted by the speakers to increase in pitch and/or volume, while deceleration in the longitudinal direction may cause engine sounds to decrease in pitch and/or volume. In some conditions, when a threshold level of deceleration in the longitudinal direction is sensed, a braking or tire skidding sound may be emitted by the speakers.

Still other sounds may be emitted by the speakers. During operation of the cockpit, engine sounds may be varied in response to variation in the position of shifter 152 as sensed by shifter sensor 534. For example, during acceleration of the carrier vehicle (as sensed by an accelerometer), the engine sounds may be increased in volume and/or pitch until the position of shifter 534 is varied by the user, wherein the volume and/or pitch of the engine sounds may be reduced or increased, for example, based on the selected position. For example, an increase in the gear selected by shifter 534 (e.g. from gear 2 to gear 3) may cause the pitch and/or volume of the engine sounds to decrease while a decrease in the gear selected by shifter 534 (e.g. from gear 2 to gear 1) may cause the pitch and/or volume of the engine to increase. Further, the sound and/or pitch of the engine sounds emitted by the speakers may be controlled to correspond to a position and/or movement of the indicators on gauges 124, 126, or 128, for example. Crashing or other damage sounds may be emitted by the speakers when the ejector unit is operated, for example, to cause steering wheel 140 or other portion of cockpit 100 to be separated or reconfigured as will be described in greater detail with reference to FIG. 8.

In some embodiments, verbal commands (e.g. via speakers 560) and/or visual commands (e.g. lights 580) may be outputted to request the user to perform various user inputs, such as turning the steering wheel and/or manipulating the shifter. As one example, a verbal command to turn left may be emitted by the speakers, wherein the user may rotate the steering wheel to turn left. As another example, a verbal command to shift to a particular gear or in a particular direction may be emitted by the speakers. The verbal and/or visual commands may be provided in response to a random or pre-programmed order stored in controller 510, or may be provided based on user input or acceleration sensor information. For example, as the carrier vehicle is accelerating, the acceleration sensor may cause controller 510 to provide a shifter or steering wheel command via the speakers and/or lights of the cockpit (e.g. command window 194). The user may be notified to up-shift, down-shift, turn left, turn right, etc. In this manner, sounds may be emitted from speakers 560 in conjunction with various outputs or inputs of the cockpit.

FIG. 6 illustrates an example routine that may be performed by the control system. For example, at 610, user input may be received such as via the steering wheel or shifter. At 612, the cockpit may provide a response or feedback to the user based on the user input. For example, lights or sounds may be emitted, one or more portions of the cockpit may be detached or reconfigured (e.g. via ejector unit 526), one or more portions of the cockpit may vibrate or move (e.g. steering wheel 140 via vibration unit 524), and/or one or more gauges may be varied to provide different information. The routine may then return where one or more different or similar operations may be performed.

At 620, controller 510 may issue one or more visual and/or verbal commands for the user to follow. At 622, it may be judged based on a comparison of the user input (i.e. user response) to the issued command whether the command has been adequately followed. If the answer is no, the cockpit may provide a response to the user at 624 via one or more of the approaches described with reference to 612. For example, if the user is commanded to turn left and instead the user rotates the steering wheel to the right, then a warning sound or crashing sound may be produced. Alternatively, if the answer at 622 is yes, then a response different from the response at 624 may be provided at 626. For example, if the user is commanded to turn left and the user responds by turning the steering wheel to the left, the cockpit may produce a different sound. The routine may then return where one or more different or similar operations may be performed.

At 630, the control system may receive carrier vehicle input, such as via environmental sensor 540. In some embodiments, a microphone or other sound input device may be included that receives environmental noise, such as the engine noise produced by the engine of the carrier vehicle. A band pass filter could be included to provide various responses based on specific sound levels or frequencies of the environmental noise. Alternatively, or in addition to sound sensing, acceleration sensing may be used. At 632, the cockpit may provide a response to the user at 632 via one or more of the approaches described above with reference to 612 based on the carrier vehicle input. The routine may then return where one or more different or similar operations may be performed.

At 640, carrier vehicle input may be received, for example, as described above with reference to 630. At 642, the controller may issue visual and/or verbal commands to the user based at least partially on the carrier vehicle input at 640. At 644, it may be judged based on a comparison of the user input to the issued command whether the command has been adequately followed. If the answer is no, the cockpit may provide a response to the user at 624 via one or more of the approaches described with reference to 612. If the answer at 622 is yes, then a response different from the response at 624 may be provided at 626. The routine may then return where one or more different or similar operations may be performed.

In some embodiments, a selector switch may enable a user to select between one or more of the modes described in FIG. 6. For example, a user may be permitted to selectively turn on or turn off one or more of the operations beginning with 610, 620, 630, or 640. In this manner, operation of the cockpit may be varied to provide the desired level of coaching, response, or feedback to the user and/or to enable selection of whether conditions of the carrier vehicle should influence the operation of the cockpit. Thus, different play modes of the cockpit may be employed. In another example, the system may randomly auto-select one of the four modes illustrated in FIG. 6, or may select them in a predetermined order.

FIG. 7 illustrates an embodiment where one or more portions of the cockpit may vibrate in response to sensed conditions. For example, a cockpit 700 such as described above with reference to cockpit 100 may include a steering wheel 140 coupled to frame 110 that vibrates during some conditions. Further, an engine portion 710 simulating a vehicle engine, intake manifold, engine block, or others may be coupled to frame 110 in a manner that enables engine portion 710 to vibrate under select conditions. As one example, as described above with reference to FIGS. 5 and 6, one or more portions of the cockpit may vibrate when the user fails to follow certain commands that are provided by the controller. Further, portions of the cockpit such as engine portion 710 may vibrate in response to a detected acceleration of the carrier vehicle. The vibration of these portions may be accompanied by corresponding sounds or control of lights.

FIG. 8 illustrates an embodiment where one or more portions of the cockpit may become separated or re-configured with respect to the cockpit frame. For example, a cockpit 800 such as described above with reference to cockpit 100 may include a steering wheel 140 and/or an engine portion 710 that are removably coupled to frame 110. During select operating conditions, steering 140 and/or engine portion 710 may be ejected or may become detached from the frame. As one example, as described above with reference to FIGS. 5 and 6, one or more portions of the cockpit may become detached when the user fails to follow certain commands that are provided by the controller. The detachment of these portions may be accompanied by corresponding sounds or control of lights.

An example scenario will be provided to illustrate how the above examples may be used in practice. A user such as a child may be seated in a passenger seat of a carrier vehicle such as an automobile. The toy cockpit such as described above with reference to cockpit 100 may be placed in front of or on the lap of the user. A driver of the carrier vehicle may begin operating the carrier vehicle by accelerating longitudinally, braking, turning left, turning right, etc. while transporting the user and the cockpit.

In response to an acceleration in the longitudinal direct such as may be caused by the driver operating the throttle of the carrier vehicle, the control system of the cockpit may detect the longitudinal acceleration and cause the cockpit to initiate a tire squeal sound and/or increase the volume and/or pitch of an engine sound produced by the cockpit, thereby simulating a corresponding acceleration of the cockpit. Alternatively or in addition to the engine sounds, the cockpit may also provide haptic feedback to the user in the form of vibration of one or more portions of the cockpit and/or may provide audible or visual command instructions to the user, such as to notify them to operate the shifter.

As the driver of the carrier vehicle applies the brake, causing longitudinal acceleration (e.g. deceleration) to be detected by the cockpit and provide audible, visual or haptic feedback to the user, such as tire skidding sounds, engine deceleration sounds (e.g. reduction in engine volume and/or pitch), and/or commands such as to again notify the user to operate the shifter. For example, the user may be commanded to downshift to a different gear.

As the driver of the carrier vehicle turns the steering wheel to the right, a lateral acceleration may be detected by the cockpit control system. In response to the detected acceleration, the cockpit may command the user to turn the wheel of the cockpit to the right and/or may be produce tire skidding or squealing sounds in response to the detected lateral acceleration and/or the user input received via the steering wheel.

As the driver of the vehicle turns to the left, a different lateral acceleration may be detected, which may cause the cockpit to command the user to turn left. If the user instead turns to the steering wheel of the cockpit to the right, the cockpit may produce visual, audible, or haptic feedback that is different from the feedback provided when the user turns in the direction indicated by the command or in common with the carrier vehicle. For example, tire squealing or skidding sounds, crashing sounds, vibrations, or separation of one or more parts of the cockpit may be provided. In this manner, the user may be encouraged, at least under some conditions, to operate the cockpit in a manner that relates to operation of the carrier vehicle.

While the description of the cockpit provided herein focused on an automobile application, it should be appreciated that the cockpit may be alternatively configured to simulate other vehicles. For example, a cockpit may simulate the cockpit of an aircraft by including a yoke or stick rather than a steering wheel, different gauges, different shifters, and different sounds and lights, among other inputs and outputs. As another example, the cockpit of a water craft such as a boat may be simulated by cockpit 100. Further, cockpits that are configured for different vehicle types may use acceleration sensing or receive acceleration information along different coordinate directions. For example, a cockpit for use with an aircraft may include acceleration sensing along the vertical axis. Further still, cockpit 100 may be used not only in automobile type vehicles, but may also be configured to respond differently when used with other carrier vehicles such as boats, airplanes, cars, buses, strollers, etc.

Note that the example control routines included herein can be used with various control system configurations. The specific routines described herein may represent one or more of any number of processing strategies such as event-driven, interrupt-driven, multi-tasking, multi-threading, and the like. As such, various steps, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated operations or functions may be repeatedly performed depending on the particular strategy being used. Further, the described operations may graphically represent code to be programmed into the computer readable storage medium in the engine control system. It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A method of operation of a toy cockpit for use with a carrier vehicle, comprising:
receiving an operator input and providing at least one of an audible output and a visual output in response thereto; and
receiving a carrier vehicle input and providing said at least one of the audible output and the visual output in response thereto.

2. The method of claim 1, wherein the operator input includes a turn of a steering wheel operatively coupled with the cockpit.

3. The method of claim 1, wherein the operator input includes a movement of a gear shift operatively coupled with the cockpit.

4. The method of claim 1, wherein the carrier vehicle input includes an acceleration.

5. The method of claim 4, wherein the acceleration includes at least one of a lateral acceleration and a longitudinal acceleration of the carrier vehicle.

6. The method of claim 5, wherein a first output is provided in response to the lateral acceleration and a second output is provided in response to the longitudinal acceleration, wherein the first output is different than the second output, and wherein the first output and the second output include at least one of an audible output, a visual output, and a haptic output.

7. The method of claim 1, wherein the carrier vehicle input includes longitudinal acceleration.

8. The method of claim 1, wherein the carrier vehicle input includes sounds produced by operation of the carrier vehicle.

9. The method of claim 1, wherein the carrier vehicle input includes at least one of a tilting of the carrier vehicle, a shaking of the carrier vehicle, an electronic signal from the carrier vehicle, and an inclination of the carrier vehicle.

10. The method of claim 1, wherein the audible output includes at least one of a verbal command, engine sounds, tire sounds, or crashing sounds.

11. The method of claim 1, wherein the visual output includes at least one of lights, adjustment of a gauge reading, a turn signal, and disassembly of components of the cockpit.

12. The method of claim 1, where said providing at least one of an audible output and a visual output in response thereto may be provided via one or more of an electronic circuit, a mechanical linkage, and a mechanical gyroscope.

13. A method of operation of a toy cockpit for use with a carrier vehicle, comprising:
generating a command instruction;
receiving an operator input after generating the command instruction;
providing a first response when said operator input follows said command; and
providing a second response when said operator input fails to follow said command.

14. The method of claim 13, wherein the command instruction includes at least one of a visual instruction and an audible verbal instruction.

15. The method of claim 13, wherein the first response includes at least one of an audible, a visual response, and a haptic response.

16. The method of claim 15, wherein the second response is different from the first response, and the second response includes at least one of an audible response, a visual response, and a haptic response.

17. The method of claim 13, wherein the command instruction is generated in response to operation of the carrier vehicle.

18. A toy, comprising:
a frame;
an input device including a hand control moveably coupled to the frame for receiving an operator input;
an accelerometer coupled to the frame for detecting acceleration;
an output device coupled to the frame for providing feedback to a user; and
a control system coupled to the frame to vary feedback provided by the output device based on the operator input and a level of acceleration detected by the accelerometer.

19. The toy of claim 18, wherein the hand control includes at least one of a steering wheel and a lever; and wherein the accelerometer detects acceleration of the frame, wherein said acceleration includes acceleration caused by a carrier vehicle and said accelerometer includes a rolling-ball inclination sensor.

20. The toy of claim 19, wherein the output device provides feedback that includes at least one of a visual feedback, an audible feedback, haptic feedback, and disassembly of the toy.
